(19) United States
(12) Patent Application Publication
(10) Pub. No.: US 2009/0077278 A1
(43) Pub. Date: Mar. 19, 2009

(54) INFORMATION PROCESSING AND DEVICE INFORMATION MANAGEMENT APPARATUS AND METHOD

(75) Inventor: Shigeki Kuroda, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/212,949

(22) Filed: Sep. 18, 2008

(30) Foreign Application Priority Data
Sep. 19, 2007 (JP) 2007-242062

(51) Int. Cl. G06F 3/00

(52) U.S. Cl. 710/58

(57) ABSTRACT

An information processing apparatus includes a receiving unit configured to receive device information sent by a peripheral device based on timing information, a setting unit configured to set timing information based on device information, and a transmission unit configured to transmit timing information set by the setting unit to a peripheral device.

### BACKGROUND OF THE INVENTION

1. Field of the Invention

The present invention relates to an information processing apparatus. More specifically, an information processing apparatus that processes device information transmitted by a peripheral device.

2. Description of the Related Art

Conventionally, there is a peripheral device that is connected to a network, such as a printer, a facsimile, a copying machine, and a multifunction peripheral (MFP) that includes functions of the aforementioned devices.

Further, in recent years, a sheet feeding unit and a sheet discharge unit (e.g., a sorter or a finisher) have become attachable to a peripheral device as an option. Consequently, items to be set as print data have become complex when a printer driver installed in an information processing apparatus generates the print data to be sent to a peripheral device.

In the above-described sheet feeding unit, a type of medium that can be set on a sheet feed stage and can be fed in a printer device is acquired by a dynamic configuration function of a printer driver. The acquired type of medium is then displayed on a driver user interface (UI).

The dynamic configuration function of the printer driver is also used to acquire a remaining amount of sheets in the sheet feed stage. The amount of remaining sheets is then displayed on the driver UI.

Further, in a sheet discharge unit, the dynamic configuration function of the printer driver is used to acquire a remaining amount of staples put in a sorter or a finisher. The acquired remaining amount is then displayed on the driver UI.

The dynamic configuration function of the printer driver is also used to acquire a remaining amount of toner in a peripheral device such as a printing apparatus. The acquired remaining amount is then displayed on the driver UI.

Further, the dynamic configuration function of the printer driver is used to acquire error information about a peripheral device, and the error information is displayed on the driver UI.

Generally, the dynamic configuration function is realized using a standard TCP/IP port of a Windows® operating system (OS).

The various information described above are acquired by the dynamic configuration function of the printer driver when the printer driver is installed in an information processing apparatus. Additionally, the information are acquired according to a user instruction, for example, when a user presses a configuration information acquisition button in a UI provided by a printer driver after installing the printer driver in the information processing apparatus. In such a case, the dynamic configuration function of the printer driver inquires the peripheral device and acquires the information.

Further, there is a case where a dynamic configuration module of the printer driver automatically inquires the peripheral device, for example, by polling and acquires information.

In particular, the first method in which a user instructs the printer driver to inquire the peripheral device is used in acquiring information about an optional configuration of the peripheral device, such as a sheet feeding unit or a sheet discharge unit.

The second method in which the printer driver automatically inquires by polling is used in detecting the remaining amount of sheets, staples, and toner, and an error in a device as described above.

For example, Japanese Patent Application Laid-Open No. 2002-044344 discusses a technique in which a dynamic configuration module of a printer driver acquires device information.

In particular, Japanese Patent Application Laid-Open No. 2002-044344 discusses an example of acquiring sheet information as device information.

On the other hand, an auto-configuration function using a Web Services on Devices (WSD) port which is a function of VISTA®, i.e., a Windows® OS has been recently realized.

In the auto-configuration function using the WSD port, the printer does not acquire driver information by inquiring the peripheral device with polling.

Instead, the peripheral device transmits information to the printer driver using the WSD port, so that the printer driver can acquire the information.

There is a case where the auto-configuration function uses the WSD port to acquire information about a status of a peripheral device with respect to consumables such as remaining amounts of staples, sheets, and toner. In such a case, the status of the peripheral device continuously changes.

Consequently, if the peripheral device transmits information about a change in the status every time a change occurs to a printer driver installed in an information processing apparatus using the WSD port, network traffic may greatly increase.

Further, a status change of a peripheral device is not constant. For example, a status of a consumable such as the above-described remaining amount of sheets or toner changes according to frequency of printing instructed from the printer driver.

Therefore, in a case where a change rarely occurs in the status of a peripheral device, the transmitted information may not be useful to an operator even if the peripheral device transmits change information to the printer driver at constant intervals.

In particular, frequencies of usage of a peripheral device are different depending on the market. For example, it is not necessary to frequently update information in an office environment. On the other hand, it is necessary to frequently update information in a print-on-demand (POD) market.

Further, in recent years, there is a method of lowering power consumption of a peripheral device such as a printing apparatus by including a standby mode, i.e., a sleep state, in a case where the printing apparatus does not receive a print request.

However, if a printer driver uses a conventional standard TCP/IP port to acquire peripheral device information when the information become necessary, the peripheral device is awakened from a sleep state.

Therefore, every time the printer driver makes an inquiry to the peripheral device to acquire the information, the peripheral device is woken up from a sleep state, so that power consumption of the peripheral device increases.

### SUMMARY OF THE INVENTION

An aspect of the present invention is directed to an information processing apparatus which can acquire device information that a peripheral device spontaneously transmits based on timing information transmitted by the information processing apparatus. Such a technique does not increase traffic between the information processing apparatus and the peripheral device.

According to an embodiment of the present invention, an information processing apparatus includes a receiving unit configured to receive device information transmitted by a peripheral device based on timing information, a setting unit configured to set the timing information based on the device information, and a transmission unit configured to transmit the timing information set by the setting unit to a peripheral device.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a block diagram of a configuration of a printing system to which an information processing apparatus according to an exemplary embodiment of the present invention is applicable.

FIG. 2 illustrates a cross-sectional view of a reader unit and a printer unit of the printing system illustrated in FIG. 1.

FIG. 3 is a block diagram of the core unit of the printing system illustrated in FIG. 1.

FIG. 4 is a block diagram of a printing system including a personal computer//workstation (PC/WS) illustrated in FIG. 1.

FIG. 5 illustrates a memory map of a random access memory (RAM) of the PC/WS illustrated in FIG. 1.

FIG. 6 illustrates a block diagram of a print data processing module in the PC/WS illustrated in FIG. 1.

FIGS. 7A and 7B are flowcharts illustrating examples of data processing procedures in an information processing apparatus and in an image processing apparatus respectively according to an exemplary embodiment of the present invention.

FIG. 8 is a flowchart illustrating an example of a data processing procedure in an information processing apparatus according to an exemplary embodiment of the present invention.

FIGS. 9A and 9B illustrate examples of a job information management table and a device information management table respectively, stored in a registry/file in the print data processing module illustrated in FIG. 6.

FIG. 10 is a flowchart illustrating an example of a data processing procedure in an information processing apparatus according to an exemplary embodiment of the present invention.

FIG. 11 illustrates an example of data transmitted from a printer driver illustrated in FIG. 6.

FIGS. 12A and 12B illustrate examples of data transmitted by a PC/WS and acquired by an image input/output control unit illustrated in FIG. 1, registered in a management table.

FIG. 13 illustrates an example of a user interface displayed on a display unit included in a PC/WS illustrated in FIG. 1.

FIG. 14 is a flowchart illustrating an example of a data processing procedure in an information processing apparatus according to an exemplary embodiment of the present invention.

FIG. 15 illustrates an example of a print job data that is corrected by a printer driver illustrated in FIG. 6.

FIGS. 16A and 16B illustrate examples of a UI displayed on a display unit included in an information processing apparatus according to an exemplary embodiment of the present invention.

FIG. 17 illustrates a memory map of a storage medium which stores various data processing programs readable by an information processing apparatus according to an exemplary embodiment of the present invention.

FIG. 18 illustrates a memory map of a storage medium which stores various data processing programs readable by an image processing apparatus according to an exemplary embodiment of the present invention.

### DETAILED DESCRIPTION OF THE EMBODIMENTS

Various exemplary embodiments, features, and aspects of the invention will be described in detail below with reference to the drawings.

### First Exemplary Embodiment

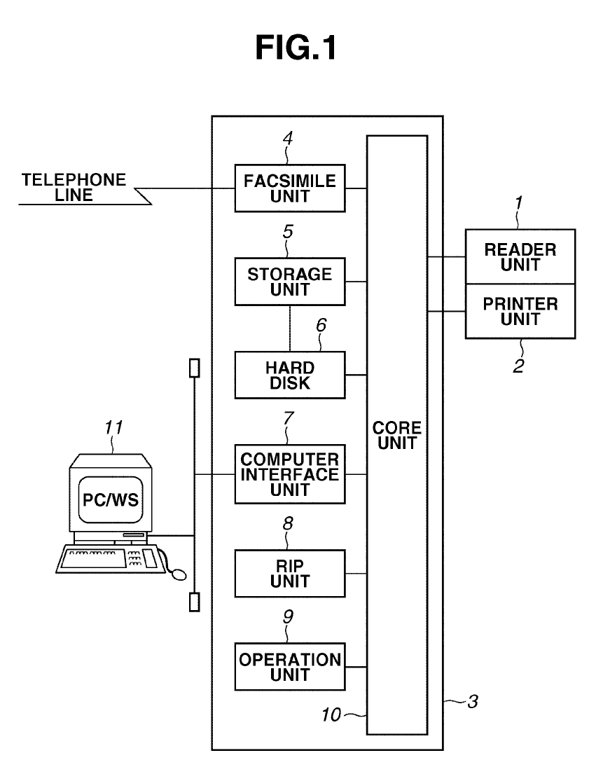

FIG. 1 illustrates a block diagram of a configuration of a printing system to which an information processing apparatus according to an exemplary embodiment of the present invention is applicable. The printing system described in the present exemplary embodiment includes a PC/WS 11 that can communicate with an image input/output control unit 3 via a network. The image input/output control unit 3 controls a reader unit 1 and a printer unit 2.

In the present exemplary embodiment, an MFP including the reader unit 1, printer unit 2, and the image input/output unit 3 will be described as an example of a peripheral device. However, the present invention can be applied to a printing apparatus that includes only a printing function, or a scanner apparatus that includes only an image reading function.

A process in which an information processing apparatus communicates with the image input/output control unit 3 that controls a peripheral device and transmits timing information or acquires device information from the peripheral device will be described below.

A device driver installed in the PC/WS 11 generates job data and can transmit the job data to the image input/output control unit 3 according to a request from an application. A device information processing operation of the information processing apparatus will be described in detail below.

Referring to FIG. 1, the image input/output control unit 3 is connected to the reader unit 1 and the printer unit 2. The reader unit 1 reads an image of an original and outputs an image data according to the original image to the image input/output control unit 3. The printer unit 2 records an image according to the image data received from the image input/output control unit 3 on a recording sheet.

The image input/output control unit 3 includes a facsimile unit 4, a storage unit 5, a computer interface unit 7, a raster image processor (RIP) unit 8, an operation unit 9, and a core unit 10.

The facsimile unit 4 decompresses a compressed image data received via a telephone line and transfers the decompressed image data to the core unit 10. Further, the facsimile unit 4 compresses image data transferred from the core unit 10 and transmits the compressed image data via the telephone line. The image data received and transmitted by the facsimile unit 4 can be temporarily stored in a hard disk 6 connected to the storage unit 5.

The storage unit 5 compresses the image data transferred from the core unit 10 and stores the image data along with an image data identification (ID) number for searching the image data in the hard disk 6.

Further, the storage unit 5 searches the compressed image data stored in the hard disk 6 based on a code data transferred via the core unit 10. The storage unit 5 then reads out and decompresses the searched compressed image data and transfers the decompressed image data to the core unit 10.

The computer interface unit 7 is an interface between an information processing apparatus configured by a PC or a WS, i.e., PC/WS 11, and the core unit 10.

The computer interface unit 7 can be connected one-to-one with the PC/WS 11 via a local interface or can be connected to the PC/WS 11 via a network. In the present exemplary embodiment, the computer interface unit 7 is connected to the PC/WS 11 via a network.

Further, the computer interface unit 7 can perform bidirectional communication with the PC/WS 11. For example, print job information or various setting information managed by the core unit 10 can be transmitted to the PC/WS 11 through the computer interface unit 7. Statuses of image input/output apparatuses, i.e., the reader unit 1 and the printer unit 2, can also be transmitted to the PC/WS 11 through the computer interface unit 7.

Device information includes information about a sheet feed stage and a sheet discharge apparatus (i.e., finisher) attached to the reader unit 1 or the printer unit 2.

Further, device information include information about sheets set on each sheet feeding stage and information about consumables such as remaining amounts of sheets, staples and toner.

Such device information is transmitted from the reader unit 1 or the printer unit 2 to the core unit 10. The device information can then be transmitted to the PC/WS 11 via the computer interface unit 7.

In such cases, the computer interface unit 7 receives an inquiry from the PC/WS 11 to acquire device information via the network. Consequently, the computer interface unit 7 inquires the core unit 10 about the information, draws out the information from the core unit 10, and transmits the information to the PC/WS 11 via the network.

In the present exemplary embodiment, a process in which the PC/WS 11 inquires a device about information and acquires the information will be referred to as a dynamic configuration.

There is a case where the inquiry from the PC/WS 11 to acquire device information does not reach the computer interface unit 7 via the network.

In such a case, the core unit 10 takes an action to transmit information, so that the computer interface unit 7 draws out information from the core unit 10 at timing of when the action is taken.

As a result, an inquiry can also be transmitted to the PC/WS 11 via the network.

In the present exemplary embodiment, a process in which the core unit 10 takes an action to transmit information, so that the image input/output control unit 3 spontaneously transmits information to the PC/WS 11, and the printer driver of the PC/WS 11 acquires the information, will be referred to as an auto-configuration using a WSD.

The RIP unit 8 in the image input/output control unit 3 rasterizes code data (i.e., page description language (PDL) data) that represents an image transferred from the PC/WS 11 into an image data that can be recorded by the printer unit 2.

The operation unit 9 includes a touch panel display and a hard key. The operation unit 9 is used to give operation instruction or make operation settings and to set sheet information to the image input/output control unit 3 via a UI.

The core unit 10 controls data flow among the reader unit 1, the printer unit 2, the facsimile unit 4, the storage unit 5, the computer interface unit 7, the RIP unit 8, and the operation unit 9. A configuration of the core unit 10 will be described below.

As described above, information distributed in bidirectional communication between the PC/WS 11 and the image input/output control unit 3 include information about a sheet feed stage and a sheet discharge apparatus (i.e., finisher).

Further, such information include device information, e.g., sheet information set to each sheet feed stage, and remaining amount of sheets on each sheet feed stage, staples, and toner. The core unit 10 manages the remaining amount of sheets of each sheet feed stage and stores the information in the storage unit 5, along with device information including remaining amounts of staples and toner.

Further, the core unit 10 manages information received by the computer interface unit 7, such as timing of transmission in an auto-configuration, and stores the information in the storage unit 5 as necessary. The storage unit 5 can also store the received information in the hard disk 6 as necessary.

The core unit 10 can read out the device information from the storage unit 5 and send the information to the computer interface unit 7 according to the transmission timing stored in the storage unit 5.

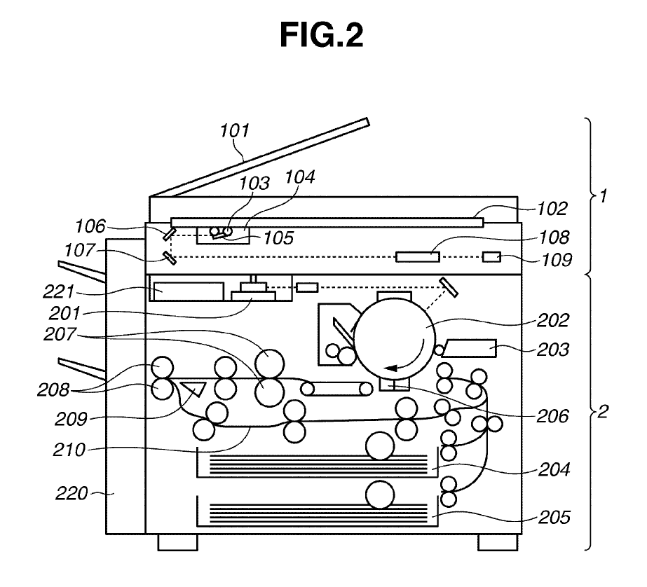

FIG. 2 illustrates a cross-sectional view of the reader unit 1 and the printer unit 2 in the printing system illustrated in FIG. 1.

Referring to FIG. 2, in the reader unit 1, a document feeding apparatus 101 feeds each page of an original onto a platen glass 102 sequentially from the first page. After reading the original, the document feeding apparatus 101 discharges the original onto the platen glass 102.

When the original is conveyed from the document feeding apparatus 101 to the platen glass 102, the reader unit 1 starts moving a scanner unit 104 while a lamp 103 is turned on. The scanner unit 104 then exposes and scans the original.

A reflected light from the original is guided to the charge-coupled device image sensor (CCD) 109 by mirrors 105, 106, 107, and lens 108.

Thus, an image of the scanned original is read by the CCD 109. An image data output by the CCD 109 is then transferred to the core unit 10 of the image input/output control unit 3 after undergoing a predetermined process.

A laser driver 221 of the printer unit 2 drives a laser emitting unit 201. More specifically, the laser driver 221 causes the laser emitting unit 201 to emit a laser beam which is modulated according to the image data output from the core unit 10 of the image input/output control unit 3.

A photosensitive drum 202 is irradiated by the laser beam via a folding mirror, and an electrostatic latent image is formed on the photosensitive drum 202 according to the laser beam. A developing unit 203 deposits a developer on a portion of the latent image of the photosensitive drum 202. A recording sheet is then fed from either of a cassette 204 or a cassette 205 in synchronization with the start of irradiating the drum with the laser beam. The recording sheet is then conveyed to a transfer unit 206, and the developer adhering to the photosensitive drum 202 is transferred to the recording sheet.

The recording sheet on which a developer is deposited is then conveyed to a fixing unit 207, and the developer is fixed on the recording sheet by heat and pressing force of the fixing unit 207.

The recording sheet which passes through the fixing unit 207 is then discharged by a discharge roller 208.

In a case where a two-side printing is set, a rotational direction of the discharge roller 208 is reversed after the recording sheet is conveyed to the discharge roller 208. A flapper 209 then guides the recording sheet to a re-feed conveyance path 210. The recording sheet which is guided to the re-feed conveyance path 210 is then fed to the transfer unit 206 at the above-described timing.

A sheet discharge apparatus 220 functions as a finisher option. When the recording sheet ejected by the discharge roller 208 is discharged outside the printer unit 2, processes such as stapling and punching can be performed as necessary. The sheet discharge apparatus 220 includes a detection unit which detects a remaining amount of staples, i.e., a consumable. Remaining amount information detected by the detection unit is notified to the core unit 10.

The core unit 10 manages the remaining amount of staples included in the sheet discharge apparatus 220, and the remaining amounts of recording sheets stored in each of the cassettes 204, 205.

As described above, the recording sheet on which a series of image processing has been performed is discharged onto the discharge tray of the sheet discharge apparatus 220.

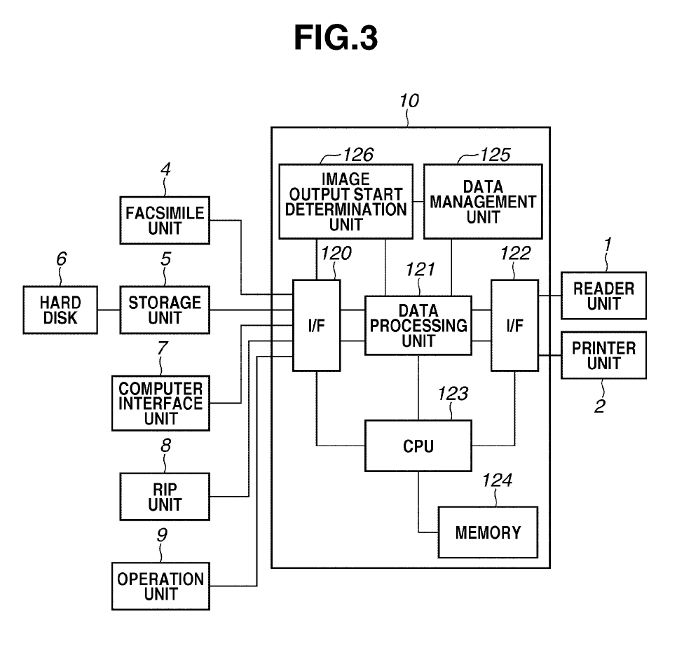

FIG. 3 illustrates a block diagram of the core unit 10 in the printing system illustrated in FIG. 1.

Referring to FIG. 3, the image data transferred from the reader unit 1 is then transferred to a data processing unit 121 via an interface (I/F) 122. The data processing unit 121 performs image processing such as image rotation and scaling, and image data compression and decompression. The data processing unit 121 includes a page memory that can store a plurality of pages of an image data that correspond to an A4/Letter size paper.

The image data transferred from the reader unit 1 to the data processing unit 121 is temporarily stored in the page memory. The image data is then compressed and transferred to the storage unit 5 via an interface (I/F) 120.

Further, a code data (i.e., PDL data) representing an image input from the PC/WS 11 via the computer interface unit 7 is transferred to the data processing unit 121 via the I/F 120. The code data is then transferred to the RIP unit 8 and rasterized into an image data.

The image data is then transferred to the data processing unit 121, temporarily stored in the page memory, and compressed and transferred to the storage unit 5. The image data is managed with an image data ID number assigned by the data processing unit 121.

The image data transferred to the storage unit 5 is then transferred to the data processing unit 121 and decompressed. After being temporarily stored in the page memory, the decompressed image data is transferred to the printer unit 2, the facsimile unit 4, or the computer interface unit 7.

The data processing unit 121 notifies a data management unit 125 of the stored image data as soon as an image data is stored in the storage unit 5. The data management unit 125 then manages the image data in association with an image data ID number assigned by the data processing unit 121.

The data management unit 125 also manages a print job stored in the hard disk 6 included in the storage unit 5, in association with a print job ID number.

Further, the core unit 10 includes an image output start determination unit 126.

After various image data transferred to the data processing unit 121 are temporarily stored in the page memory, the data processing unit 121 can transfer the image data to the printer unit 2, the facsimile unit 4, or the computer interface unit 7 before transferring the image data to the storage unit 5.

In such a case, the data processing unit 121 can transfer the image data to the printer unit 2, the facsimile unit 4, or the computer interface unit 7 by switching an internal selector.

A central processing unit (CPU) 123 in the core unit 10 controls data processing performed by each unit according to a control program stored in a memory 124 or a control command transferred from the operation unit 9. The memory 124 is also used as a work area of the CPU 123.

A process of detecting remaining amounts of sheets, staples and toner to be managed by the image input/output control unit 3 and processing of such information will be described below with reference to FIGS. 2 and 3.

A sensor formed inside the cassette 204 or the cassette 205 illustrated in FIG. 2 detects the remaining amount of sheets in the cassette 204 or the cassette 205. The detected remaining amount of sheets is then stored in the storage unit 5 via the I/F 122 of the core unit 10.

Similarly, a remaining amount of toner detected by a sensor inside a toner cartridge is stored in the storage unit 5 via the core unit 10.

Further, a remaining amount of staples is similarly detected by a staple sensor attached to a stapler included in the sheet discharge apparatus 220. The detected remaining amount of staples is then stored in the hard disk 6 of the storage unit 5 via the I/F 120.

Such information about remaining amounts is stored in the memory 124 via the data processing unit 121 and the CPU 123 as necessary. The remaining amounts of sheets, staples and toner stored in the memory 124 can be processed by the image input/output control unit 3.

As described above, the core unit 10 of the image input/output control unit 3 can perform a process that integrates functions such as document image reading, image printing, image transmission, and image storage, via the data processing unit 121 and the storage unit 5.

Further, the image input/output control unit 3 can perform image processing that integrates functions for processing the remaining amounts of sheets, toner, and staples and data received from the PC/WS 11.

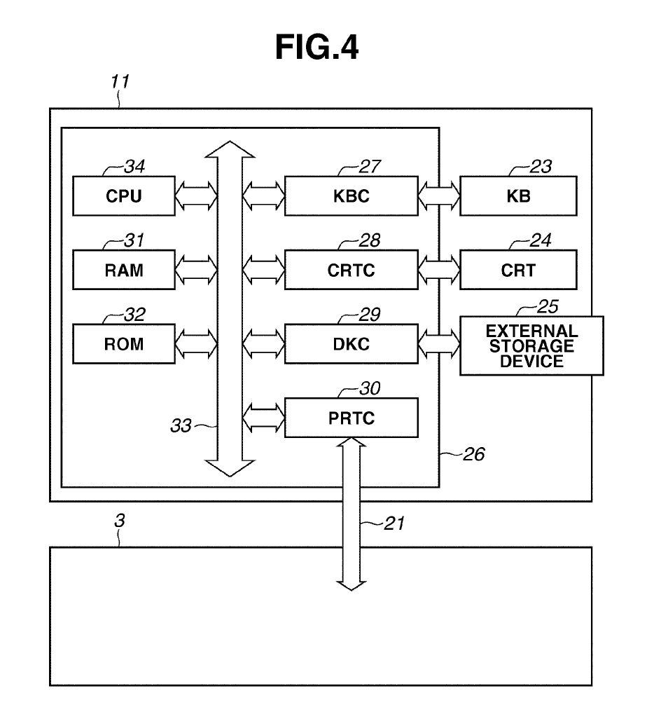

FIG. 4 illustrates a block diagram of a printing system including an information processing apparatus (PC/WS 11) illustrated in FIG. 1.

Since the image input/output control unit 3 described in the present invention is required to perform a predetermined bidirectional communication, the image input/output control unit 3 is connected to the PC/WS 11 via a network 21. The present exemplary embodiment describes an information processing system in which the image input/output control unit 3 and the PC/WS 11 which is a host computer are communicably connected via the network (i.e., local area network (LAN)) 21.

However, the present invention can also be applied to an information processing system in which the PC/WS 11 and the image input/output control unit 3 are connected by a local interface such as a universal serial bus (USB) or IEEE1394, instead of the network 21.

Referring to FIG. 4, the PC/WS 11 includes a keyboard (KB) 23 by which an operator inputs arbitrary data, and a display unit (cathode ray tube, i.e., CRT 24) which displays the given data. Further, the PC/WS 11 includes an external storage device 25 such as a floppy disk or a hard disk which stores boot program, various application programs, font data, user file, and edit file.

A controller unit 26 controls the entire PC/WS 11. The controller unit 26 can also be referred to as an information processing apparatus.

The controller unit 26 includes a keyboard controller (KBC) 27 which controls key input data that is input from the keyboard 23 or input data designated by a pointing device (not illustrated).

A CRT controller (CRTC) 28 controls the CRT 24. A disk controller (DKC) 29 controls accessing of the external storage device 25.

A printer controller (PRTC) 30 controls communication between the PC/WS 11 and the image input/output control unit 3. A RAM 31 functions as a work area for programs executed by a CPU 34. A read-only memory (ROM) 32 stores a predetermined print control program or a Basic Input/output System (BIOS) for controlling the input/output. The CPU 34 performs overall control of devices connected to a system bus 33.

The external storage device 25 is not limited to a hard disk which is integrated with or connected to the PC/WS 11. The external storage device 25 can be a recording medium such as a floppy disk (FD), a compact disk (CD), a CD-readable (CD-R), a CD-rewritable (CD-RW), a magneto optical disk (MO), a digital versatile disc (DVD), or an optical disk. In such a case, the DKC 29 corresponds to a drive that reads out data from the recording medium.

An auto-configuration function by which the image input/output control unit 3 transmits current device information to the PC/WS 11 will be described below.

As described above, device information includes information about a sheet feed stage and a sheet discharge apparatus (i.e., finisher) attached to the reader unit 1 and the printer unit 2. Further, device information includes information about sheets set to the sheet feed stage and remaining amounts of sheets, toner and staples. Such device information is sent from the reader unit 1 and the printer unit 2 to the CPU 123 via the I/F 122 illustrated in FIG. 3, and then stored in the memory 124. There is a case where the device information is stored in the storage unit 5 via the I/F 120.

If the PC/WS 11 on a network notifies the image input/output control unit 3 of acquiring timing of device information via the computer interface unit 7, the received timing information is transmitted to the CPU 123 via the I/F 120 and stored in the memory 124.

Further, the timing information can also be stored in the storage unit 5 via the I/F 120.

The CPU 123 then acquires the timing information stored in the memory 124 or in the storage unit 5 and performs control to monitor timing of information transmission. The timing information is transmitted by the PC/WS 11 at timing indicated in a flowchart described below.

At the timing of transmission, the CPU 123 acquires the device information stored in the memory 124. The CPU 123 can also acquire the device information stored in the storage unit 5 via the I/F 120.

The CPU 123 then transmits the acquired device information to the computer interface unit 7 via the I/F unit 120.

A process performed by the PC/WS 11 to cause a printing apparatus to operate according to the present invention will be described below.

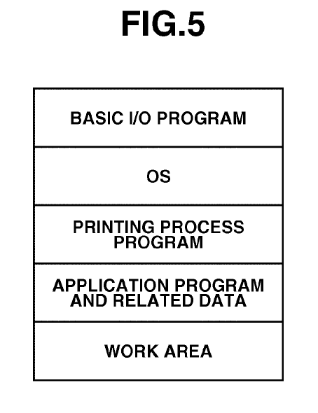

FIG. 4 is a block diagram illustrating a configuration of a printing system. FIG. 5 illustrates a memory map of a RAM 31 in the PC/WS 11 illustrated in FIG. 1.

Referring to FIG. 5, the PC/WS 11 performs operations with the CPU 34 executing a basic I/O program, an OS, and a printing program.

The basic I/O program is written in the ROM 32 inside the PC/WS 11, and the OS is written in an HD inside the PC/WS 11 or the external storage device 25 such as an FD.

When the PC/WS 11 is switched on, an initial program loading (IPL) function inside the basic I/O program is executed.

Then, the OS stored in the HD inside the information processing apparatus (PC/WS 11) or in the external storage device 25 such as an FD is read by the RAM 31 in the PC/WS 11 and is executed.

An operator then selects a command image from a command menu displayed on a screen of the CRT 24 in the PC/WS 11 using the keyboard 23 or a pointing device.

By the above-described procedure, the operator instructs execution of an application, and the application stored in the HD or the external storage device 25 is read into the RAM 31. The CPU 34 then executes the application and thus performs various data processing.

The operator then instructs printing by a similar procedure as when starting the application. Consequently, a printing program which includes a function to synthesize print data, and a printer control command generation program (i.e., printer driver) stored in the HD or the external storage device 25 are read into the RAM 31. Thus, the printing system is activated.

In the present exemplary embodiment, the printing program and related data are stored in an FD, and a configuration of the stored content is illustrated in FIG. 5.

The printing program and the related data are stored in the FD inside the PC/WS 11 and can be loaded on the RAM 31 through the DKC 29 inside the PC/WS 11. More specifically, when the FD is inserted in the external storage device 25, the OS and the basic I/O program perform control to read out the printing program and the related data from the FD. After the printing program and the related data are loaded on the RAM 31 in the PC/WS 11, the CPU 34 executes the printing program, so that the printing process of the present exemplary embodiment is realized.

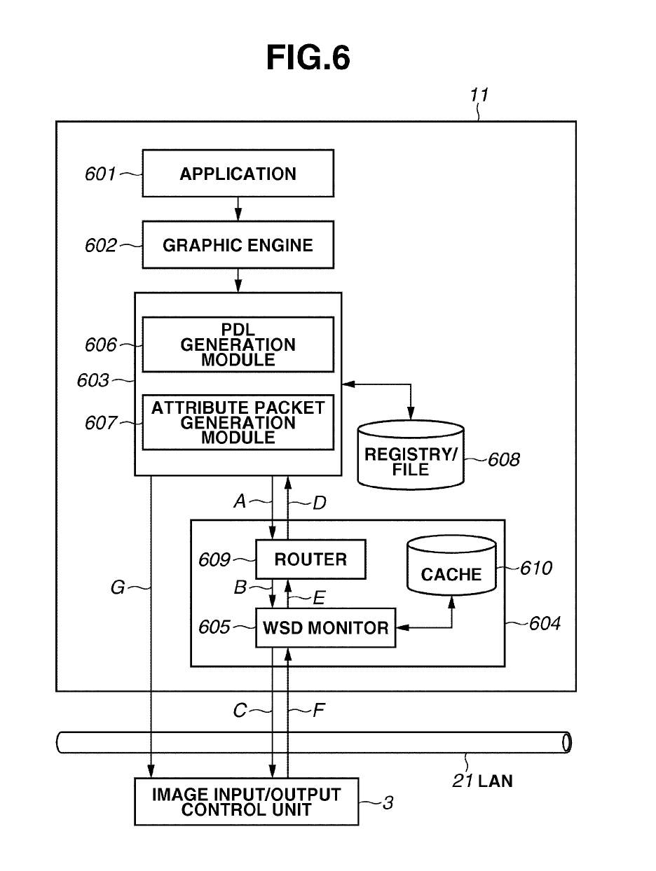

FIG. 6 illustrates a block diagram of a print data processing module inside the PC/WS 11 illustrated in FIG. 1. Referring to FIG. 6, reference letters A to G indicate paths of data exchange between each of modules.

Referring to FIG. 6, the print data processing module of the PC/WS 11 in the present exemplary embodiment include an application 601, a graphic engine 602, a printer driver 603, and a system spooler 604.

The printer driver 603 includes a PDL generation module 606 and an attribute packet generation module 607. The system spooler 604 includes a router 609, a WSD monitor 605, and a cache 610.

The various modules are files stored in the external storage device 25 of the PC/WS 11. Further, the modules are loaded on the RAM 31 in the PC/WS 11 by the OS or a module using such modules, and executed by the CPU 34.

The application 601 and the printer driver 603 can be supplied from a recording medium (not illustrated) such as an FD or a CD-ROM, or can be supplied to the hard disk of the PC/WS 11 via a network. When the application 601 performs printing using the printer unit 2, the graphic engine 602 is used to perform output (i.e., rendering).

To be more specific, the application 601 generates a desired document in response to a user operation. When the user gives a print instruction, the application 601 causes the graphic engine 602, i.e., a rendering unit provided by the OS, to output the document in a form of a rendering function.

In a case where the OS is a Windows® OS, the graphic engine 602, i.e., a rendering unit, is referred to as a graphic device interface (GDI).

In such a case, the application 601 converts the document to be printed into a rendering function defined by the GDI of the OS and outputs the GDI function (i.e., the rendering function) to the GDI, or the graphic engine 602.

Further, when an instruction to start printing is received from the application 601, the graphic engine 602 loads the printer driver 603 of each printing apparatus on the RAM 31 and sets an output of the application 601 to the printer driver 603.

The graphic engine 602 then converts the GDI function received from the application 601 into a device driver interface (DDI) function and outputs the DDI function to the printer driver 603.

The printer driver 603 then converts the DDI function received from the graphic engine 602 into a control command that is recognizable by the image input/output control unit 3. An example of such a control command is a print control command based on PDL.

The printer driver 603 then generates a print data based on the converted print control command and sends the print data to the system spooler 604 loaded by the OS (i.e., path A). In the system spooler 604, the print data passes through the router 609 and the WSD monitor 605 (i.e., path B) and is output to the computer interface unit 7 of the image input/output control unit 3 (i.e., path C).

In the present exemplary embodiment, the printer driver 603 performs auto-configuration using the above-described WSD. As a result, the printer driver 3 receives a notification from the image input/output control unit 3 about device information including remaining amount of sheets, using the WSD monitor 605 and the router 609 in the system spooler 604.

The WSD monitor 605 in the system spooler 604 communicates with the image input/output control unit 3 by connecting via a WSD port defined on a Windows® OS (i.e., paths C and F).

Further, the router 609 in the system spooler 604 can be connected to the image input/output control unit 3 via the WSD port and communicate with the image input/output control unit 3 (i.e., path E). In a case where there is a change in an environmental status of devices controlled by the image input/output control unit 3 such as the printer unit 2, the image input/output control unit 3 notifies the WSD monitor 605 of the change. The image input/output control unit 3 notifies the WSD monitor 605 using a WS-Event defined on the Windows® OS (i.e., path F).

For example, the image input/output control unit 3 can notify the PC/WS 11 of a change in a sheet feeding unit or a discharge unit (i.e., a finisher option) included in the printer unit 2 controlled by the image input/output control unit 3 using a WS-Event.

Further, the image input/output control unit 3 can notify the PC/WS 11 of a change in an environmental status of a device such as the printer unit 2 controlled by the image input/output control unit 3. The notification can be transmitted at timing of switch-on or -off of power after there is a change in the system configuration as described above.

If the above-described timing information is set to the image input/output control unit 3, the image input/output control unit 3 controls the timing of notifying of a WS-Event. That is, the image input/output control unit 3 can notify the PC/WS 11 of the WS-Event at set timing.

The WS-Event is defined by a SOAP message which is a protocol described in an extended mark-up language (XML). The image input/output control unit 3 notifies the PC/WS 11 of a WS-Event which only indicates that there is a change in status.

Further, the image input/output control unit 3 can notify the PC/WS 11 of a type of information that has been updated. More particularly, the image input/output control unit 3 can notify the PC/WS 11 whether the remaining amount of staples, toner or sheets in each of sheet feed stages (including cassettes 204 and 205) has been undated among a status change of the printer unit 2.

Upon receiving a WS-Event from the image input/output control unit 3, the WSD monitor 605 transmits a Soap message, i.e., a GetPrintEvent, to the image input/output control unit 3 with respect to an item notified by the WS-Event. The WSD monitor 605 transmits the GetPrint Event via the WSD port (i.e., path C).

The GetPrintEvent is also a message defined by an XML format.

The WSD monitor 605 then acquires a latest status of the device information through the GetPrintEvent Soap message (i.e., path F). The WSD monitor 605 can acquire only the items in the device information in which there have been a change as notified by the WS-Event.

After acquiring the device information as described above, the WSD monitor 605 determines whether there is a difference between the acquired device information and device information that are cached in the cache 610 in the system spooler 604.

Consequently, only in a case where there is a difference between the acquired device information and the device information cached in the cache 610, the WSD monitor 605 notifies the printer driver 603 of the device information acquired from the image input/output control unit 3 via the path D. To be more specific, the WSD monitor 605 notifies the printer driver 603 of the acquired information through the WSD port of the router 609 on the system spooler 604.

Further, the WSD monitor 605 caches the latest device information in the cache 610 in the system spooler 604. The WSD monitor 605 uses the cached device information in a next determination of whether there is a difference between acquired device information.

On the other hand, in a case where there is no difference between the acquired latest device information and the cached device information, the WSD monitor 605 determines that there is no change in the printer unit 2.

By performing the above-described process, information in the printer driver 603 are not affected even in a case where device information are not notified to the printer driver 603 when there is no change.

The router 609 in the system spooler 604 then notifies the printer driver 603 of device information in which there is a change. The router 609 notifies in a form of an argument for calling the DrvPrinterEvent function of the printer driver 603. The argument is described in the XML format and can notify the printer driver 603 of information about individual devices.

The printer driver 603 can store the device information acquired from the router 609 in a registry/file 608.

The printer driver 603 can also read out information stored in the registry/file 608 as necessary and display the information on a driver UI that can be displayed on the CRT 24.

Further, the printer driver 603 in the present exemplary embodiment can function as a printer driver of the printer server.

In such a case, information stored in the registry/file 608 can be notified to a printer driver of a client connected by point-and-print (not illustrated).

The printer driver 603 separately includes a unit that directly communicates with the image input/output control unit 3 just as a conventional printer driver (i.e., path G). The path G uses a conventional TCP/IP port and can transmit information of the printer driver 603 to the image input/output control unit 3 or inquire information of the image input/output control unit 3 using a Management Information Base (MIB).

Further, the printer driver 603 can communicate with the image input/output control unit 3 using a Web service in the path G. The printer driver 603 can communicate with the image input/output control unit 3 via a dynamic configuration module or a Web service module (not illustrated) when conducting communication using the MIB or the Web service.

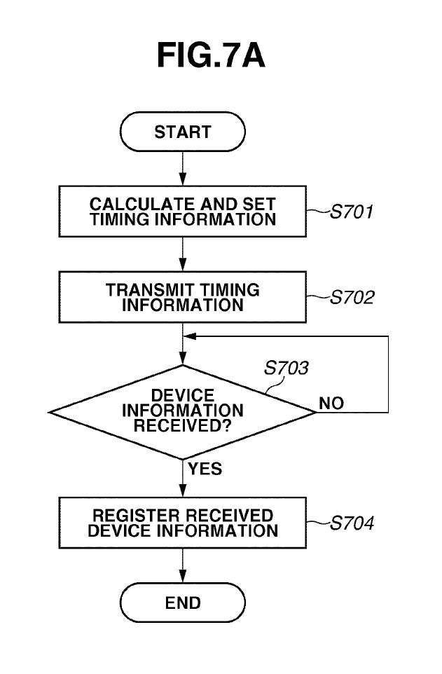

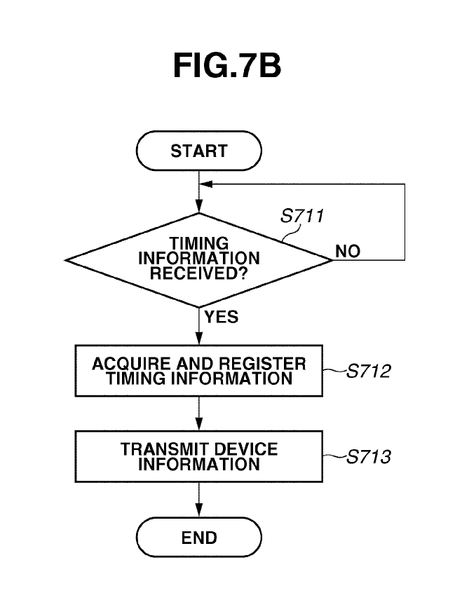

FIG. 7A is a flowchart illustrating an example of a data processing procedure in an information processing apparatus according to the present exemplary embodiment. The present process is an example in which the information processing apparatus receives device information. The CPU 34 of the PC/WS 11 illustrated in FIG. 4 realizes each step in the flowchart executing a module illustrated in FIG. 6 which the CPU 34 loads in the RAM 31.

FIG. 7B is a flowchart illustrating an example of a data processing procedure in an image processing apparatus according to the present exemplary embodiment. The present procedure is an example of a process in which the image processing apparatus transmits information about a device such as the printer unit 2 to the information processing apparatus, according to timing information received from the information processing apparatus. The CPU 123 of the image input/output control unit 3 illustrated in FIG. 3 realizes each step in the flowchart executing a control program which the CPU 123 loads in the memory 124.

In step S701 of the flowchart illustrated in FIG. 7A, the CPU 34 calculates and sets information about timing of the image input/output control unit 3 to transmit device information about the printer unit 2 using an auto-configuration function. The CPU 34 calculates and sets the timing information inside the printer driver 603.

In step S702, the PRTC 30 of the PC/WS 11 illustrated in FIG. 4 then transmits the timing information set inside the printer driver 603 in step S701 to the image input/output control unit 3.

In step S711 of the flowchart illustrated in FIG. 7B, the CPU 123 determines whether the data processing unit 121 of the image input/output control unit 3 has received the timing information from the PC/WS 11. If the data processing unit 121 has received the timing information (YES in step S711), the process proceeds to step S712. In step S712, the CPU 123 records the received timing information in the memory 124.

In step S713, the image input/output control unit 3 transmits device information about the printer unit 2 to the PC/WS 11 via the I/F 120 based on the acquired timing information. The process illustrated in the flowchart of FIG. 7B then ends.

In step S703 of the flowchart illustrated in FIG. 7A, the CPU 34 then determines whether the PC/WS 11 has received the device information transmitted from the image input/output control unit 3 in step S713 of the flowchart illustrated in FIG. 7B. In a case where the PC/WS 11 has received the device information (YES in step S703), the process proceeds to step S704. In step S704, the device information received from the image input/output control unit 3 is transferred to the system spooler 604 and stored in the cache 610. The process illustrated in the flowchart of FIG. 7A then ends.

The process of calculating timing performed by the image processing apparatus in step S701 of the flowchart illustrated in FIG. 7A will be described below.

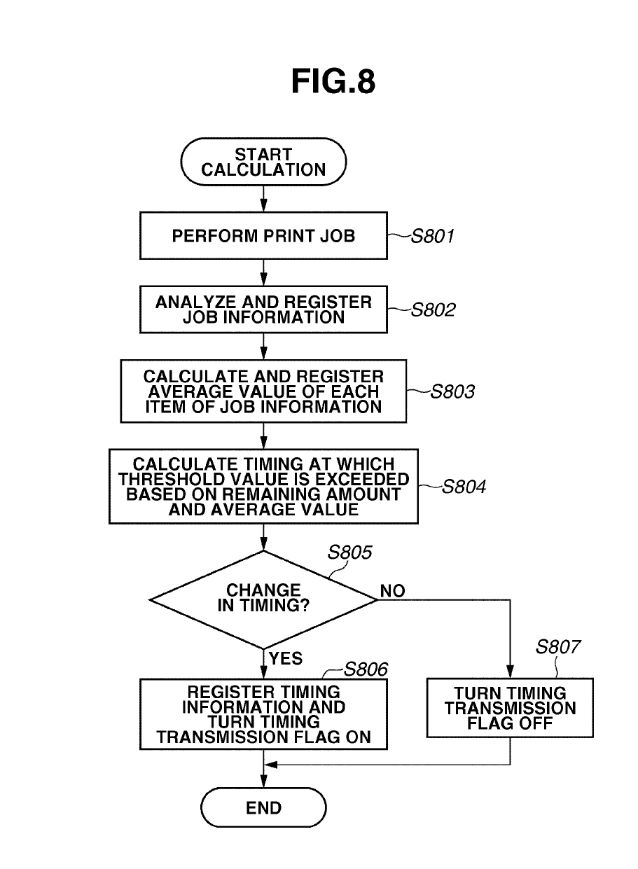

FIG. 8 is a flowchart illustrating an example of a data processing procedure in an information processing apparatus in the present exemplary embodiment. The process is an example in which the PC/WS 11 calculates timing of transmitting device information that the image input/output control unit 3 notifies to the PC/WS 11. In the present exemplary embodiment, a printer driver is described as an example of a device driver.

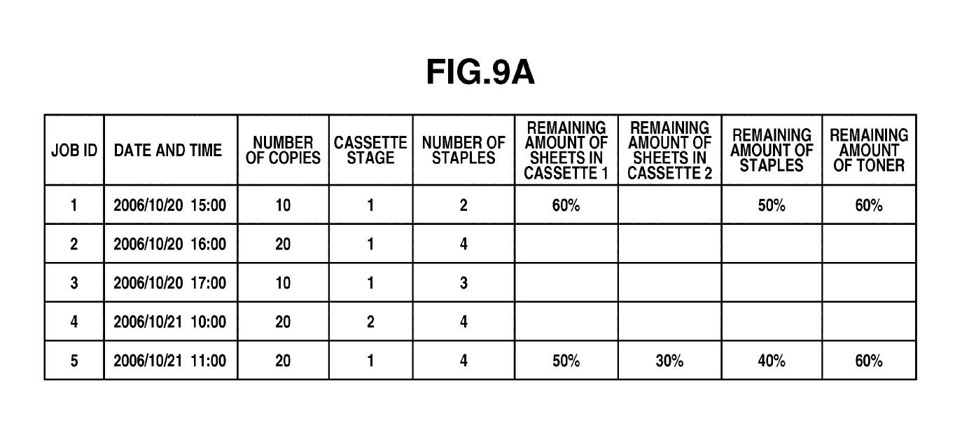

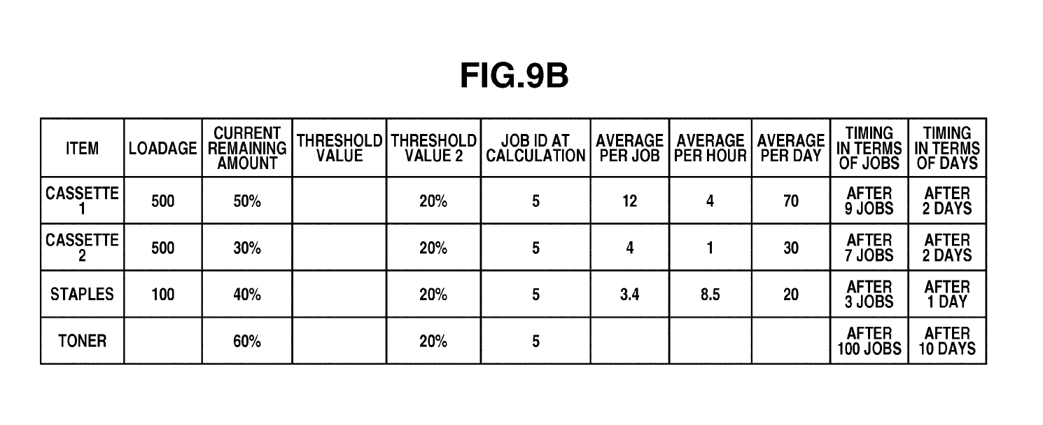

In the present exemplary embodiment, the printer driver 603 manages an amount of a consumable, e.g., number of sheets and amount of staples or toner which are consumed by job data transmitted to the image input/output control unit 3, as a job log. Further, the printer driver 603 manages remaining amounts of consumables of each device that are notified from an image processing apparatus as a job log. Further, the printer driver 603 calculates transmission timing according to a threshold value that is set as illustrated in FIG. 9B which will be described below. The image input/output control unit 3 spontaneously notifies the PC/WS 11 of information about each device at transmission timing notified from the PC/WS 11.

The transmission timing omits a period in which the printer unit 2 is in a sleep state.

Each step in the flowchart illustrated in FIG. 8 is realized by the CPU 34 of the PC/WS 11 loading the printer driver 603 in the RAM 31 and executing the printer driver 603.

In step S801, the printer driver 603 in the PC/WS 11 processes the above-described print job. The print job processing includes creation of a PDL by the PDL generation module 606 and a process of creating a print job that is to be transmitted to the image input/output control unit 3, by the attribute packet generation module 607.

In step S802, the printer driver 603 analyzes information about the created print job and registers the job information in the registry/file 608. Since the printer driver 603 can process the print job, the printer driver 603 can also analyze the print job.

The above-described job information that is analyzed and recorded are, for example, a print job number, a print date and time, a total number of copies to be printed in the print job, information about each specified sheet feed stage, and a number of staples in a case of a staple job.

FIG. 9A illustrates an example of a job information management table stored in the registry/file 608 illustrated in FIG. 6.

Referring to FIG. 9A, print job information, i.e., job ID, date and time, number of sheets, cassette tray, and number of staples, are stored in the corresponding columns respectively.

In the present exemplary embodiment, the latest device information can be acquired when the image input/output control unit 3 outputs a print job, as will be described below.

Here, an acquiring of device information by an information processing apparatus is defined as receiving of the device information from the device when a print job is processed as will be described below.

Consequently, the job information management table illustrated in FIG. 9A stores the latest device information acquired at timing of the print job process. More specifically, the job information management table stores a remaining amount of sheets (i.e., remaining amount in cassette), a remaining amount of staples, and a remaining amount of toner.

For example, items of device information that are acquired after a print job of job ID “1” is output include a remaining amount of sheets in cassette 1, staples, and toner. The cassette 1 corresponds to the cassette 204 attached to the printer unit 2.

Referring to FIG. 9A, values of the remaining amount of sheets in cassette 1, staples, and toner in the job information management table are 60%, 50%, and 60% respectively.

Further, items of device information that are acquired after a print job of job ID “5” is output include remaining amounts of sheets in cassette 1 and cassette 2, staples, and toner. The values of each of the items are 50%, 30%, 40%, and 60% respectively.

Further, for example, when a job whose job ID of “2” is processed, the information management table stores information that a print date and time is 2006/10/20 16:00, the cassette 1 is designated as a sheet feed stage, a number of sheets to be output is 20 sheets, and four copies have been stapled.

In step S803 of the flowchart illustrated in FIG. 8, the printer driver 603 calculates an average value of each item using job information that the printer driver 603 analyzed and registered in step S802. The printer driver 603 then registers the calculated average values in a device information management table illustrated in FIG. 9B.

FIG. 9B illustrates an example of a device information management table stored in the registry/file 608 illustrated in FIG. 6. The table illustrated in FIG. 9B is an example in which timing information is determined in terms of jobs or in terms of days.

In the present exemplary embodiment, the printer driver 603 calculates an average number of output sheets per job, hour, or day in each sheet feed stage that correspond to cassettes 1, 2.

Further, the printer driver 603 calculates an average number of staples used per job, hour, or day.

Referring to FIG. 9B, the calculation results of the printer driver 603 are registered in columns of “average per job”, “average per hour”, and “average per day” in association with the job ID in the device information management table. The device information management table illustrated in FIG. 9B will be described in detail below.

The columns in the information management table illustrated in FIG. 9B include items that can be acquired as device information.

In the present example, the items to be acquired are cassette 1, cassette 2, staples and remaining amount of toner. The cassette 1 corresponds to the cassette 204 and the cassette 2 corresponds to the cassette 205.

Further, since a loadable amount is pre-defined for items other than the toner, the loadable amount is pre-stored in a column of “loadage”. In addition, latest acquired device information stored in the job information management table illustrated in FIG. 9A is stored in a column of a current remaining amount in the information management table illustrated in FIG. 9B.

The example illustrated in FIG. 9B stores device information acquired after processing the job identified by job ID 5 illustrated in FIG. 9A. Further, a threshold value in the device information management table illustrated in FIG. 9B is a value that previously defines an interval at which each remaining amount is to be displayed.

For example, the threshold value of the cassette 1 is 20%. More specifically, the remaining amount of sheets in the cassette 1 is acquired every time the remaining amount of sheets in the cassette 1 decreases by 20%.

Accordingly, since the loadage of sheets (i.e., maximum loadage) is 500 sheets and the threshold value is 20% for the cassette 1, an accurate remaining amount is acquired every time 100 sheets are used. The threshold value can be preset by the printer driver 603 or can be set on a UI of the printer driver 603.

As described above, according to the present exemplary embodiment, a threshold value is set to the device information. As a result, an information processing apparatus can acquire the device information that a peripheral device spontaneously transmits as illustrated in FIG. 9B, according to timing information transmitted by the information processing apparatus. At this time, the peripheral device is in a state in which data can be processed instead of a quiescent state, so that it is not necessary to cancel a sleep mode to acquire the device information.

In step S804 of the flowchart illustrated in FIG. 8, the printer driver 603 calculates the next timing at which the threshold value will be exceeded in terms of jobs or days. The printer driver 603 calculates using the average value calculated in step S803, the latest acquired remaining amount of sheets, and the defined threshold value.

For example, in the cassette 1 illustrated in FIG. 9B, the loadage is 500 sheets and the present remaining amount is 50%. Consequently, it can be estimated that the remaining amount of sheets is approximately 250 sheets. Since the threshold value is 20%, a correct remaining amount is acquired at every 100 sheets as described above. Further, an average number of sheets used per job is 12 sheets.

Therefore, the printer 603 can calculate that the next time the remaining amount of sheets reaches 100 sheets is after performing 9 jobs, and a value of “after 9 jobs” is set in a column of job timing. When the threshold value is 20%, the job timing is calculated as after 9 jobs. Actually, the device information is acquired after printing 108 sheets instead of 100 sheets. That is, device information is acquired at a value in proximity of the threshold value.

Similarly, an example of calculating timing in terms of days instead of jobs will be described below.

For example, with reference to FIG. 9B, loadage of the cassette 2 is 500 sheets and the present remaining amount is 30%. Consequently, it can be estimated that the remaining amount of sheets is approximately 150 sheets. Since the threshold value is 20%, a correct remaining amount is acquired at every 100 sheets as described above. Further, an average number of sheets used per day is 30 sheets. An average amount of usage per day corresponds to an average number of printouts per day.

Therefore, the printer driver 603 can calculate that the next timing at which 100 sheets will be reached is 2 days later, and a value of 2 days is set in the column of timing in terms of days illustrated in FIG. 9B.

Other examples can be similarly calculated. Thus, the printer driver 603 can calculate timing information in terms of jobs or days.

The present exemplary embodiment describes a case where timing information is calculated in terms of jobs or days. However, timing information can also be calculated in terms of a combination of jobs and days.

Further, each item in the device information management table illustrated in FIG. 9B is calculated for each print job.

In step S805 of the flowchart illustrated in FIG. 8, the printer driver 603 determines whether timing information calculated in step S804 has been updated from the previous timing information. The previous timing information is latest timing information stored in the job information management table illustrated in FIG. 9A.

If the printer driver 603 determines that the timing information has been updated (YES in step S805), the process proceeds to step S806. In step S806, the printer driver 603 stores the newly calculated timing information in the device information management table illustrated in FIG. 9B. The printer driver then sets a timing transmission flag on, and the process ends.

On the other hand, if the printer driver 603 determines that the timing information has not been updated (NO in step S805), the process proceeds to step S807. In step S807, the printer driver 603 sets the timing transmission flag off without updating the timing information in the device information management table illustrated in FIG. 9B. The process then ends.

In the above-described exemplary embodiment, timing information is automatically calculated for each device in terms of jobs or days. However, timing information can be preset for each item.

Further, an administrator can operate a driver UI of the printer driver 603 and instruct timing information. The set timing information and the specified timing information are stored in the device information management table illustrated in FIG. 9B as timing information to be used by the printer driver 603 as will be described below.

A process of transmitting timing information performed by the information processing apparatus in step S702 will be described below.

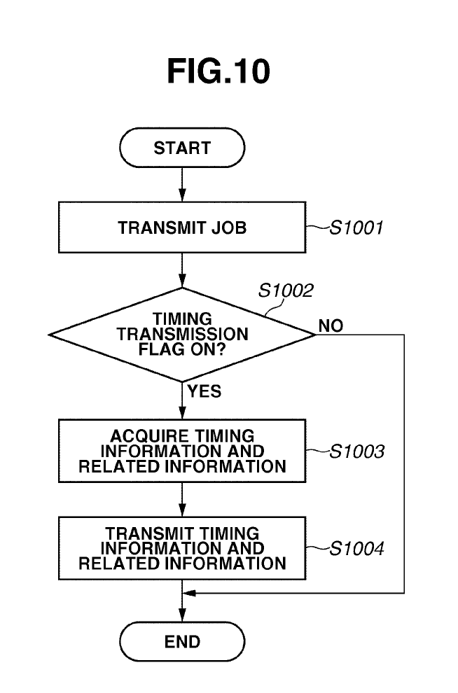

FIG. 10 is a flowchart illustrating an example of a data processing procedure in an information processing apparatus according to the present exemplary embodiment. Each step in the flowchart is realized by the CPU 34 of the PC/WS 11, loading a printer driver 603 in the RAM 31 and executing the printer driver 603.

In step S1001, the printer driver 603 sends a print job to the image input/output control unit 3 via the paths A, B, and C illustrated in FIG. 6.

In step S1002, the printer driver 603 determines whether the timing transmission flag described in the flowchart illustrated in FIG. 8 is on. If the printer driver 603 determines that the timing transmission flag is on (YES in step S1002), the process proceeds to step S1003. In step S1003, the printer driver 603 reads the timing information and the related information stored in the device information management table illustrated in FIG. 9B in step S806.

In step S1004, the printer driver 603 transmits the timing information and the related information to the image input/output control unit 3. The process then ends.

On the other hand, if the printer driver 603 determines that the timing transmission flag is off (NO in step S1002), the printer driver 603 does not transmit the timing information, and the process ends.

A transmission path of the timing information will be described below with reference to FIG. 6.

A print job generated by the printer driver 603 is transmitted to the image input /output control unit 3 via paths A, B, and C using the WSD port.

In contrast, the printer driver 603 directly transmits the timing information to the image input/output control unit 3 via the path G without using the WSD port.

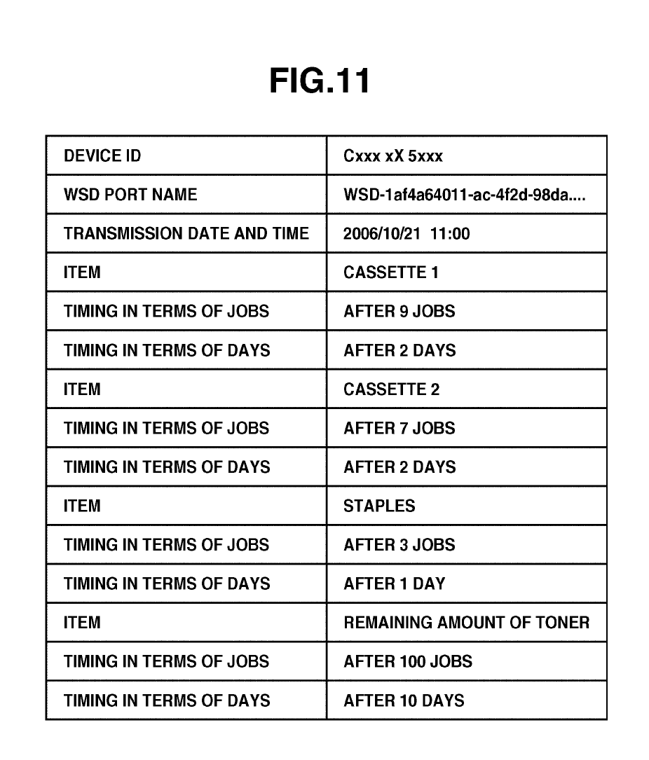

FIG. 11 illustrates an example of data to be transmitted by the printer driver 603 illustrated in FIG. 6. In the present example, the transmitted data is data that the printer driver 603 transmits to the image input/output control unit 3 in step S1004 of the flowchart illustrated in FIG. 10. The transmission data sets timing information that are to be separately acquired for each item as device information such as cassettes 1, 2, staples, and remaining amount of toner.

Referring to FIG. 11, the transmission data includes device ID of an image input/output apparatus to which the data is to be transmitted, name of the connected WSD port, and transmission date and time.

Further, the transmission data includes timing information stored in the device information management table illustrated in FIG. 9B. Such transmission data are listed sequentially.

The printer driver 603 transmits the transmission data to the image input/output control unit 3 by packet transmission using the TCP/IP port or using MIB, or via a path using the WEB service.

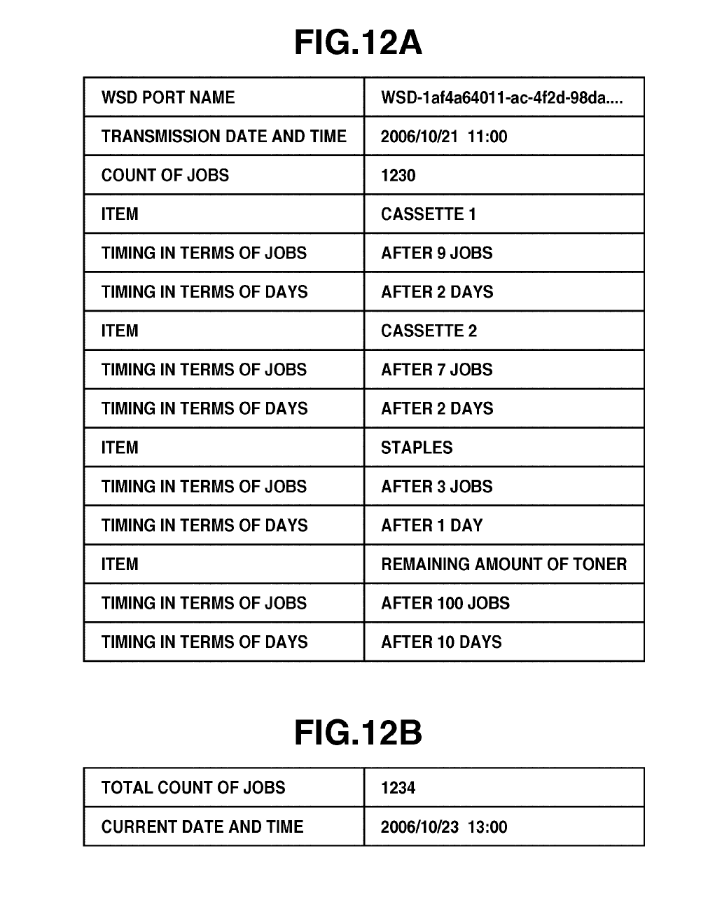

A process of acquiring and registering timing information by the image input/output control unit 3 in step S712 in the flowchart illustrated in FIG. 7B will be described below with reference to FIGS. 12A and 12B.

FIGS. 12A and 12B illustrate examples of transmitted data that the image input/output control unit 3 acquires from the PC/WS 11 and registers in a management table.

In step S712 of the flowchart illustrated in FIG. 7B, the data processing unit 121 in the image input/output control unit 3 acquires the timing information transmitted from the printer driver 603 of the PC/WS 11 via the computer interface unit 7. The data processing unit 121 then registers the acquired timing information in the memory 124 via the I/F 120 and the CPU 123. Simultaneously, the data processing unit 121 registers the acquired timing information in the storage unit 5.

In the registered data illustrated in FIG. 12A, the timing information acquired by the data processing unit 121 from the printer driver 603 in the PC/WS 11 are registered including data managed inside the image input/output control unit 3. Each data is managed for each port of the WSD connected to the image input/output control unit 3.

The data processing unit 121 stores the timing information transmitted from the printer driver 603 with the WSD port name, transmission date and time, and a total number of jobs inside the image input/output control unit 3 at the time of acquiring the timing information.

In the example illustrated in FIG. 12A, a transmission date and time from a printer driver connected to the WSD port WSD-1af4a64011-aac-4f2d-98da . . . is 2006/10/21 11:00.

Further, the total job count at the above-described date and time is 1230 jobs.

FIG. 12B illustrates data managed by the image input/output control unit 3. The data stores the total number of jobs that has been processed so far, and the current time.

A process of transmitting device information by the image input/output control unit 3 in step S713 of the flowchart illustrated in FIG. 7B will be described below.

The image input/output control unit 3 transmits the device information to the PC/WS 11 based on the timing information stored in the management tables illustrated in FIGS. 12A and 12B.

To be more precise, the data processing unit 121 transmits a WS-Event message to the corresponding WSD port based on transmission timing of each item illustrated in FIG. 12A.

The data processing unit 121 then receives a GetPrintElement message from the WSD monitor 605 of the PC/WS 11 and transmits the device information to the PC/WS 11. The device information can be transmitted at separate timing for each of cassette 1, cassette 2, and staples.

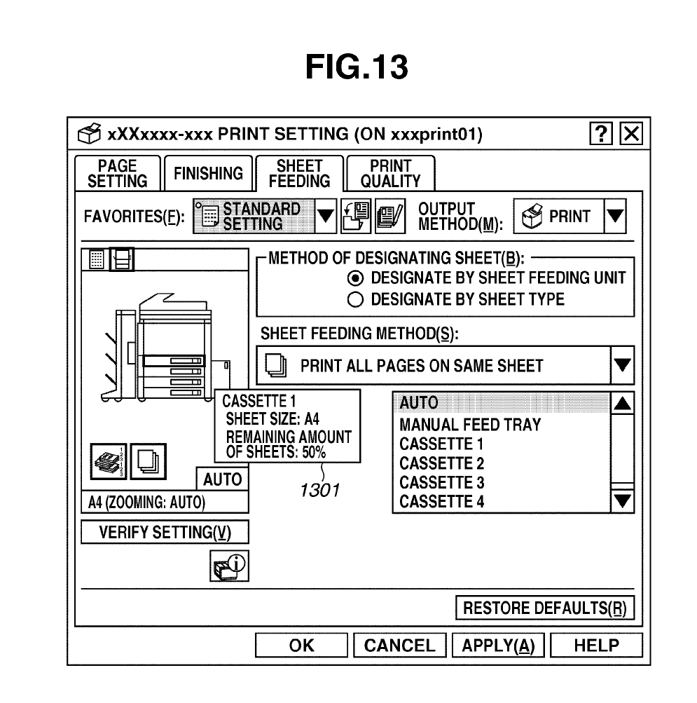

FIG. 13 illustrates an example of a UI displayed on a display unit included in the PC/WS 11 illustrated in FIG. 1. In the present example, remaining amounts of sheets and staples are displayed as device information on the UI provided by the printer driver 603.

Referring to FIG. 13, a remaining amount of sheets in the cassette 1 is displayed as 50% along with sheet size data information. According to the present exemplary embodiment, an operator clicks the cassette 1 in a bit map image representing an external view of the image processing apparatus displayed in the device state area within the UI. In response, the printer driver 603 displays a remaining amount 1301 on the UI screen. Remaining amounts of staples and toner can be similarly displayed. However, a method of displaying each of the remaining amounts is not limited to the above-described method.

### Second Exemplary Embodiment

A second exemplary embodiment of the present invention describes transmitting of timing information by an information processing apparatus in step S702 of the flowchart illustrated in FIG. 7A, which is different from the process described in the first exemplary embodiment.

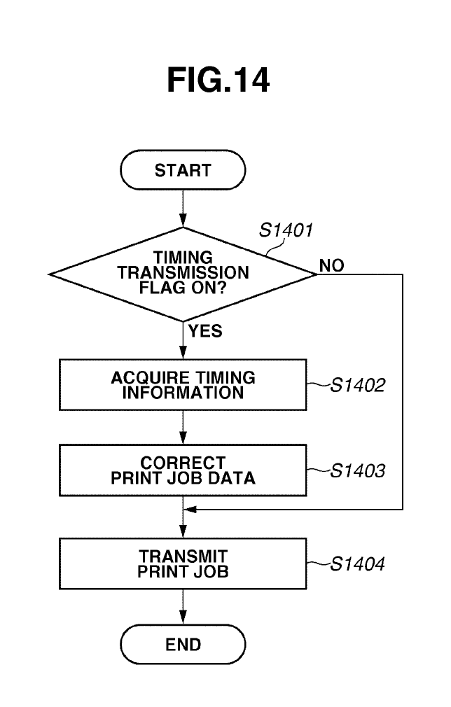

FIG. 14 is a flowchart illustrating an example of a data processing procedure in an information processing apparatus according to the present exemplary embodiment. Each step in the flowchart is realized by the CPU 34 of the PC/WS 11, loading the printer driver 603 in the RAM 31 and executing the printer driver 603. The present example describes adding timing information to a print job and transmitting the timing information.

As described above, in step S1001 of the flowchart illustrated in FIG. 10, the printer driver 603 transmits a print job to the image input/output control unit 3 via the paths A, B, and C illustrated in FIG. 6.

In step S1401 of the flowchart illustrated in FIG. 14, the printer driver 603 then determines whether the timing transmission flag described in the flowchart illustrated in FIG. 8 is on. If the printer driver 603 determines that the timing transmission flag is on (YES in step S1401), the process proceeds to step S1402. In step S1402, the printer driver 603 reads and acquires the timing information and the related information stored in step 806 of the flowchart illustrated in FIG. 8 from the device information management table illustrated in FIG. 9B.

In step S1403, the printer driver 603 corrects print job data, so that the acquired timing information is added to the print job data presently being output as information.

In step S1404, the printer driver 603 then transmits the print job including the timing information to the image input/output control unit 3 via the paths A, B, and C. The process then ends.

On the other hand, if the printer driver 603 determines that the timing transmission flag is off (NO in step S1401), the process proceeds to step S1404 without correcting the print job data.

According to the above-described exemplary embodiment, the printer driver 603 transmits the print job data to which the timing information are added, to the image input/output control unit 3 via the system spooler 604 using the WSD port. As a result, the printer driver 603 can transmit the timing information without using other ports.

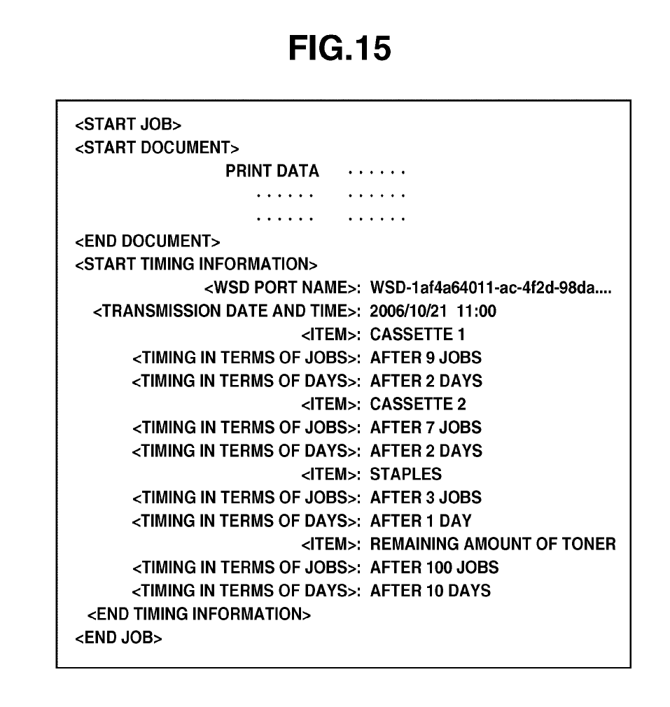

FIG. 15 illustrates an example of a print job data corrected by the printer driver 603 illustrated in FIG. 6.

The example illustrated in FIG. 15 describes content of the print job data corrected in step S1404 of the flowchart illustrated in FIG. 14.

Referring to FIG. 15, the print job data includes timing information described in the device information management table illustrated in FIG. 9B.

Further, the print job data includes device ID of an image input/output apparatus to which the data is to be transmitted, a connected WSD port name, and date and time of transmission as related content.

In the print job data illustrated in FIG. 15, the print job itself starts at <job start> and ends at <job end>.

The print data is started at <document start> and ends at <document end>. The print data is created in a general print job creation process.

The timing information are started at <timing information start> and end at <timing information end> after the print data.

The timing information between <timing information start> and <timing information end> are added to the print job in step S1403 of the flowchart illustrated in FIG. 14 after the print job is created.

Only the timing information are added in step S1403.

A process of acquiring and registering the above-described timing information to be added to the print job data by the image input/output control unit 3 in step S704 of the flowchart illustrated in FIG. 7A will be described below.

The image input/output control unit 3 acquires the above-described print job data via the computer interface unit 7 and transmits the print job data to the data processing unit 121 via the I/F 120.

The data processing unit 121 analyzes the print job data and performs a printing process. Simultaneously, the data processing unit 121 also determines whether the print job data includes timing information.

In a case where the data processing unit 121 determines that the print job data includes the timing information, the CPU 123 registers the timing information in the memory 124. At the same time, the data processing unit 121 registers the timing information in the storage unit 5. The content of the timing information to be registered is similar to that illustrated in FIG. 12, and description will be omitted.

According to the above-described exemplary embodiment, the printer driver 603 can transmit the timing information when executing a print job. Consequently, an image input/output apparatus which is in a sleep state does not have to be awakened to receive the timing information. Therefore, an increase in energy consumption can be reduced.

### Third Exemplary Embodiment

A third exemplary embodiment of the present invention describes calculating and setting of timing information by an image processing apparatus in step S701 of the flowchart illustrated in FIG. 7A which is different from the process in the above-described exemplary embodiment.

In the present exemplary embodiment, timing information acquired from the printer driver 603 is not automatically determined from a job printing status. Instead, an operator designates the timing information on the UI of the printer driver 603.

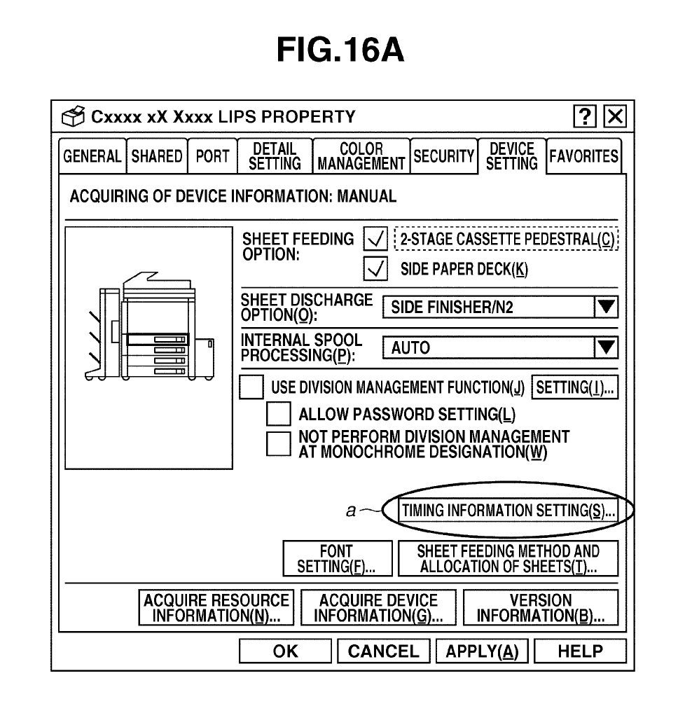

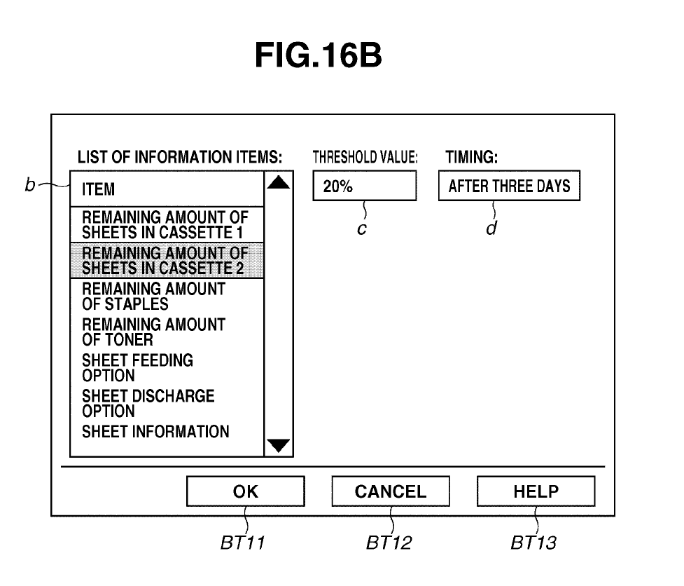

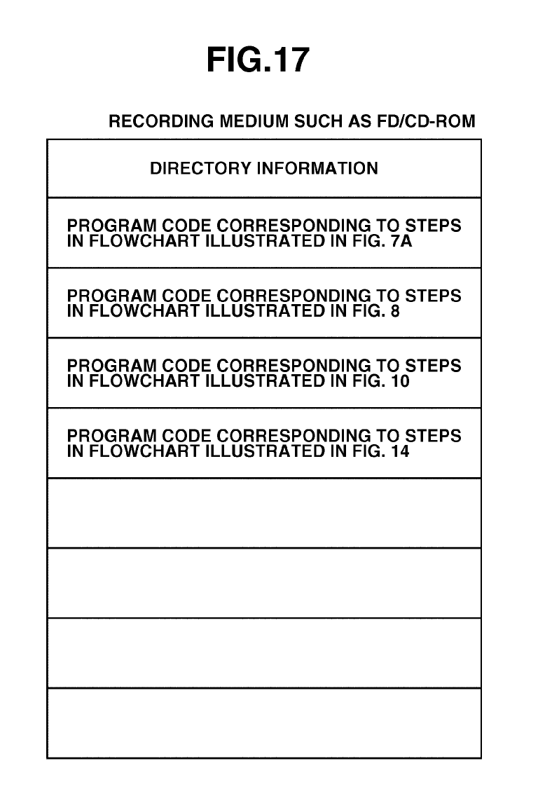

FIGS. 16A and 16B illustrate examples of UI displayed on a display unit provided in an information processing apparatus according to the present exemplary embodiment. The UI illustrated in FIG. 16B includes buttons BT11, BT12, and BT13.

FIGS. 16A and 16B illustrate examples of screens for setting timing information on a UI provided by the printer driver 603. FIG. 16A illustrates a state in which a device setting sheet is displayed on the UI provided by the printer driver 603.

Referring to FIG. 16A, a button a is a button for setting timing information. When an operator presses the button a, a UI for setting timing information illustrated in FIG. 16B is opened.

FIG. 16B illustrates a list box b as an example of a list box that displays a list of items of the device information. The example illustrated in FIG. 16B lists remaining amounts of sheets in cassettes 1 and 2 and remaining amounts of staples and toner.

Items such as sheet feed option, sheet discharge option, and sheet information can also be listed as device information in addition to remaining amounts.

The operator selects an item that the operator desires to set by clicking the desired item on the list box indicated in FIG. 16B.

A control box c is used to set a threshold value of an item selected by the operator by clicking the item on the list box b. A control box d is used to set the timing information. In the example illustrated in FIG. 16B, the operator selects cassette 2 as the item to be set, and sets the threshold value at 20% and the timing as after three days to the cassette 2.

The threshold value set using the control box c illustrated in FIG. 16B will be described in detail below.

The threshold value can synchronize with the timing at which the printer driver 603 switches the display on the UI.

For example, if the operator designates the threshold value as 10%, the remaining amount of sheets can be displayed on the UI of the printer driver 603 in 11 steps, i.e., from 100% to 0% at an interval of 10%.

Further, if the operator sets the threshold value at 20%, the remaining amount of sheets can be displayed on the UI of the printer driver 603 in 6 steps, i.e., 100%, 80%, 60%, 40%, 20%, and 0% at an interval of 20%.

The UI illustrated in FIG. 13 displays the remaining amount of sheets in cassette 1 as 50%. In a case where the operator designates on the UI a threshold value of the remaining amount of sheets in cassette 1 as 10%, it can be considered that the display is next switched when the remaining amount of sheets becomes 40%.

More specifically, a threshold value that the operator inputs in the control box c can be considered to indicate timing at which the UI provided by the printer driver 603 switches the display.

Generally, the printer driver 603 retains an initial value of the threshold value. Therefore, the initial value can be set as the threshold value in the control box c illustrated in FIG. 16B when the printer driver 603 first opens the UI.

Further, a timing value can be set in terms of a number of jobs as described above, in the control box d illustrated in FIG. 16B.

Further, “not acquired” can also be set as the timing information. In such a case, timing is set as infinite for the corresponding items, and the image input/output control unit 3 can be set to not transmit device information about the corresponding items.

The above-described values of timing information that the operator sets on the UI of the printer driver 603 are registered in the registry/file 608, similarly as in the above-described exemplary embodiment.

Consequently, the printer driver 603 reads out the timing information from the registry/file 608 as necessary and can use the timing information as described above.

More specifically, the threshold value and timing information designated by an operator on the UI illustrated in FIG. 16B can be transmitted to the image input/output control unit 3 as manually-set timing information.

In such a case, the image input/output control unit 3 spontaneously transmits device information to the PC/WS 11 every time the designated threshold value or timing is reached.

In the present exemplary embodiment, the process of transmitting timing information from the printer driver 603 to the image input/output control unit 3 is similar to the method described in the first and second exemplary embodiments. Further, the process of transmitting device information from the image input/output control unit 3 to the PC/WS 11 is similar to the method described in the first and second exemplary embodiments.

According to the above-described exemplary embodiment, when the image input/output control unit 3 transmits device information to the printer driver 603, timing information for transmitting the device information can be set from the printer driver 603.

Further, the image input/output control unit 3 can transmit device information to the printer driver 603 at individual timing for each item set in the corresponding device information according to the timing information.

As a result, for example, device information about consumables included in the printer unit 2 that is controlled by the image input/output control unit 3 does not have to be continually transmitted. Such device information includes remaining amount of staples, sheets and toner. More specifically, a peripheral device controlled by the image input/output control unit 3 in which a status change continuously occurs, does not have to transmit the device information to the PC/WS 11 every time there is a change in the information, unlike a conventional peripheral device.

The image input/output control unit 3 can thus spontaneously transmit the device information to the PC/WS 11 at a timing set by the printer driver 603. Therefore, an increase in network traffic can be reduced.

Further, an operator can set timing at which the device information that changes according to print frequency is acquired from the printer driver 603 via the UI provided by the printer driver 603. The acquired timing can be then transmitted to the image input/output control unit 3.

As a result, unnecessary transmission in acquiring information about a device controlled by the image input/output control unit 3 whose status rarely changes and which is not useful for an operator can be reduced.

Further, the device information can be acquired from the image input/output control unit 3 at timing of switching a display on an UI provided by the printer driver 603. Consequently, transmission of unnecessary information that is not reflected on the UI can be reduced.

Further, the device information can be appropriately acquired for environments in which a print frequency of a printer driver is different, such as in an office market and a POD market.

Further, a sleep state of the image input/output unit 3 does not have to be cancelled only to transmit the device information, by causing transmission timing of the device information to come after performing a print job. Therefore, an increase in energy consumption can be reduced.

### Fourth Exemplary Embodiment

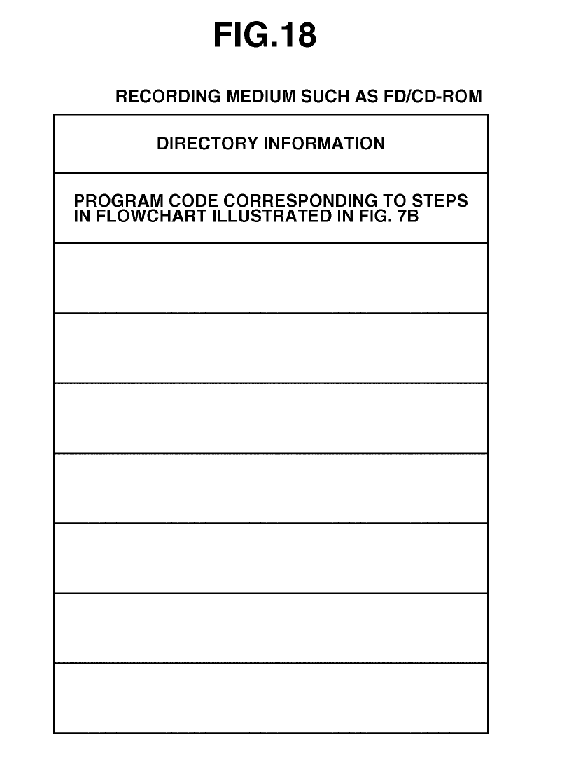

A data processing program that is readable by an information processing apparatus according to an exemplary embodiment of the present invention will be described below, with reference to memory maps illustrated in FIGS. 17 and 18.

FIGS. 17 and 18 illustrate memory maps of a storage medium that stores various data processing programs that are readable by an information processing apparatus according to an exemplary embodiment of the present invention.

Further, information that manage program groups stored in the storage medium, such as version information and creator, and information that depends on an OS of an apparatus that reads the program, such as an icon to be displayed to identify a program, can be stored in the storage medium (not illustrated).

Data that is dependent on the various programs are managed in the above-described directory. Further, a program for installing the various programs in a computer or a program for decompressing a compressed program that is to be installed can be stored in the storage medium.

Further, functions illustrated in FIGS. 7A, 7B, 10, 14 can be performed by a host computer executing a program installed from an external source. In such a case, the present invention is applicable if an information group including the program is supplied to an output apparatus from a storage medium such as a CD-ROM, flash memory, or FD, or from an external storage medium via a network.

The present invention can also be achieved by providing a storage medium which stores software (program code) for implementing functions of the above-described exemplary embodiments, to a system or an apparatus. The program code stored in the storage medium can be read and executed by a computer (central processing unit (CPU) or micro-processing unit (MPU)) of the system or the apparatus.

In this case, the software (program code) itself realizes the novel functions of the above-described exemplary embodiments. The software (program code) itself and the storage medium which stores the software (program code) constitute the present invention.

A computer executable program to implement the above-mentioned exemplary embodiments can take any form readable by computer, for example, an object code, a program executed by an interpreter, or script data supplied to an operating system(OS).

The storage medium can be, for example, a floppy disk, a hard disk, a MO, a compact disc-read-only memory (CD-ROM), a CD-R, a CD-RW, a magnetic tape, a nonvolatile memory card, a ROM, or a DVD.

In this case, the software (program code) itself realizes the functions of the above-described exemplary embodiments. The software (program code) itself and the storage medium which stores the software (program code) constitute the present invention.

Such software (program code) can also be supplied by the system or the apparatus accessing a web page on the Internet through the browser of a client computer. The software (program code) itself or a compressed file including an auto-install function can be downloaded from the web page onto a hard disk. In addition, the program code can be broken up into a plurality of files, and each file can be downloaded from different web pages. Namely, the present invention can be applied to a World Wide Web (WWW) server or a file transfer protocol (FTP) server that allow numerous users to download the program files so that the functions or processes of the present invention can be realized on their computers.

Furthermore, such software (program code) can be encrypted and stored in a storage medium, such as a CD-ROM, to be distributed to users. A user who meets given conditions can download the key information for decrypting the program from a web page through the Internet. By using the key information, the encrypted program can be executed and installed in a computer to realize the functions of the present invention.

Furthermore, the above-described exemplary embodiments can be not only realized by executing software (program code) read by a CPU. An operating system (OS) or the like working on a computer can also perform a part or the whole of processes according to instructions of the software (program code) and realize functions of the above-described exemplary embodiments.

Furthermore, software (program code) read from a storage medium can be stored in a memory equipped in a function expansion board inserted in a computer or a function expansion unit connected to a computer, and a CPU in the function expansion board or the function expansion unit can execute all or a part of the processing based on the instructions of the software (program code) to realize the functions of the above-described exemplary embodiments.

According to an exemplary embodiment of the present invention, an information processing apparatus can acquire device information which is spontaneously transmitted from a peripheral device based on timing information transmitted by the information processing apparatus. Such a process can be performed without increasing traffic between the information processing apparatus and the peripheral device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-242062 filed Sep. 19, 2007, which is hereby incorporated by reference herein in its entirety.

What is claimed is:

1. An information processing apparatus comprising:
a receiving unit configured to receive device information transmitted by a peripheral device based on timing information;
a setting unit configured to set the timing information based on the device information; and
a transmission unit configured to transmit the timing information set by the setting unit to the peripheral device.

2. An information processing apparatus according to claim 1, further comprising a display unit configured to display information about a remaining amount of a consumable of a peripheral device,
wherein the setting unit sets the timing information based on the device information so the timing information can be acquired in proximity of a threshold value of information about a remaining amount of the consumable displayed on the display unit.

3. An information processing apparatus according to claim 1, wherein the timing information includes job information.

4. An information processing apparatus according to claim 1, wherein the timing information includes day information.

5. An information processing apparatus according to claim 1, wherein the setting unit sets the timing information based on the device information including information about a remaining amount of a consumable and an average number of printouts.

6. An information processing apparatus according to claim 1, wherein the setting unit sets the timing information for each item based on the device information.

7. A method comprising:
receiving device information transmitted by a peripheral device based on timing information;
setting the timing information based on the device information; and
transmitting the timing information set by the setting unit to the peripheral device.

8. A method according to claim 7, further comprising:
displaying information about a remaining amount of a consumable of a peripheral device, and
setting the timing information based on the device information so that the timing information can be acquired in proximity of a threshold value of information about a remaining amount of the consumable displayed on the display unit.

9. A method according to claim 7, wherein the timing information includes job information.

10. A method according to claim 7, wherein the timing information includes day information.

11. A method according to claim 7, wherein the timing information is set based on the device information including information about a remaining amount of a consumable and an average number of printouts.

12. A method according to claim 7, wherein the setting unit sets the timing information for each item based on the device information.

13. A computer-readable storage medium storing a program which causes an information processing apparatus to function as an apparatus comprising:
a receiving unit configured to receive device information transmitted by a peripheral device based on timing information;
a setting unit configured to set the timing information based on the device information; and
a transmission unit configured to transmit the timing information set by the setting unit to the peripheral device.

14. A computer-readable storage medium according to claim 13, wherein the information processing apparatus further includes a display unit configured to display information about a remaining amount of a consumable of a peripheral device, and
wherein the setting unit sets the timing information based on the device information so the timing information can be acquired in proximity of a threshold value of information about a remaining amount of the consumable displayed on the display unit.

15. A computer-readable storage medium according to claim 13, wherein the timing information includes job information.

16. A computer-readable storage medium according to claim 13, wherein the timing information includes day information.

17. A computer-readable storage medium according to claim 13, wherein the setting unit sets the timing information based on the device information including information about a remaining amount of a consumable and an average number of printouts.

18. A computer-readable storage medium according to claim 13, wherein the setting unit sets the timing information for each item based on the device information.
